(19) United States
(12) Patent Application Publication
(10) Pub. No.: US 2013/0171038 A1
(43) Pub. Date: Jul. 4, 2013

(54) MAGNETIC FLUX CHANNEL COUPLED PLASMA REACTOR

(71) Applicant: Dae-Kyu CHOI, Gyeonggi-do (KR)

(72) Inventor: Dae-Kyu CHOI, Gyeonggi-do (KR)

(21) Appl. No.: 13/734,781

(22) Filed: Jan. 4, 2013

(30) Foreign Application Priority Data
Jan. 4, 2012 (KR) 10-2012-0001247

(51) Int. Cl. B01J 19/12

(52) U.S. Cl. CPC B01J 19/12
USPC 422/186.03

(57) ABSTRACT

A magnetic flux channel coupled plasma reactor includes a hollow reactor body having a plasma discharge space coupled to magnetic flux channels, a magnetic flux channel coupled plasma source including magnetic cores having two or more magnetic flux entrances forming the magnetic channel and primary winding coils wound in the magnetic cores and generating magnetic flux channel coupled plasma in the plasma discharge space, and an AC switching power supply for supplying plasma generation power to the primary winding coils and the capacitively coupled electrodes. The magnetic flux channel coupled plasma reactor independently generates the magnetic flux channel coupled plasma or hybrid plasma through capacitively coupled electrodes or inductive antenna coils in the inside of the reactor body.

### CROSS-REFERENCE TO RELATED APPLICATION

This application claims priority of Korean patent application numbers 10-2012-0001247 filed on Jan. 4, 2012. The disclosure of each of the foregoing applications is incorporated herein by reference in its entirety.

### BACKGROUND

1. Technical Field

The present invention relates to a plasma reactor for generating activated gas containing ions, free-radical, atoms, and molecules by a plasma discharge and performing a plasma processing for a solid, powder, gas, etc. with the activated gas, and more particularly to a plasma reactor for generating a magnetic flux channel coupled plasma.

2. Background Art

A plasma discharge has been used for gas excitation for generating activated gas containing ions, free-radical, atoms and molecules. The activated gas is widely used in various fields, and is representatively used in various semiconductor manufacturing processes, such as etching, deposition, cleaning, and ashing.

Recently, a wafer or a Liquid Crystal Display (LCD) glass substrate for manufacturing a semiconductor device becomes larger. In this respect, there is a need of an easily extensible plasma source having a high capability for controlling of plasma ion energy and a capability for processing a large area. It is known that remotely using the plasma is very useful in the process of manufacturing the semiconductor using plasma. For example, the remote use of the plasma has been usefully used in a cleaning of a process chamber or an ashing process for a photoresist strip. However, since a volume of the process chamber increases according to the enlargement of a substrate to be processed, a plasma source capable of remotely and sufficiently supplying high-density activated gas has been demanded.

In the meantime, a remote plasma reactor (or remote plasma generator) uses a transformer coupled plasma source or an inductively coupled plasma source. The remote plasma reactor using the transformer coupled plasma source has a structure in which a magnetic core having a first winding coil is mounted a reactor body having a toroidal structure. The remote plasma reactor using the inductively coupled plasma source has a structured in which an inductively coupled antenna is mounted in a reactor body having a hollow tube structure.

Since the remote plasma reactor having the transformer coupled plasma source is operated in a relatively high-pressure atmosphere according to a characteristic thereof, it is difficult to ignite plasma or maintain the ignited plasma in a low-pressure atmosphere. The remote plasma reactor having the inductively coupled plasma source can be operated in a relatively low-pressure atmosphere according to a characteristic thereof, but supplied power should be increased such that remote plasma reactor having the inductively coupled plasma source can be operated in a high-pressure atmosphere, so in this case, the inside of the reactor body may be damaged due to ion bombardment.

Accordingly, a remote plasma reactor efficiently operating at a low pressure or a high pressure is required according to various demands in the semiconductor manufacturing process. However, the conventional remote plasma reactor employing one of the transformer coupled plasma source and the inductively coupled plasma source failed to appropriately respond to the demands.

### SUMMARY OF INVENTION

Accordingly, an object of the present invention to provide a magnetic flux channel coupled plasma reactor which has a high capability in control of plasma ion energy and a capability of processing of a large area to be easily extendible.

Another object of the present invention to provide a magnetic flux channel coupled plasma reactor capable of generating hybrid plasma in which magnetic flux channel coupled plasma is combined with capacitively coupled plasma or inductively coupled plasma so as to achieve a wide operation region from a low-pressure region to a high-pressure region.

In order to attain the above object, one aspect according to the preferable embodiments of the present invention provides a magnetic flux channel coupled plasma reactor including: a hollow reactor body having a plasma discharge space coupled to magnetic flux channels; a magnetic flux channel coupled plasma source including magnetic cores having two or more magnetic flux entrances forming the magnetic channel and primary winding coils wound in the magnetic cores and generating magnetic flux channel coupled plasma in the plasma discharge space; capacitively coupled electrodes capacitively coupled while the plasma discharge space is interposed therebetween to generate capacitively coupled plasma in the plasma discharge space; and an AC switching power supply for supplying plasma generation power to the primary winding coils and the capacitively coupled electrodes.

According to an embodiment, the reactor body is formed of a dielectric body.

According to an embodiment, the magnetic flux channel coupled plasma reactor includes a conductive reactor body cover surrounding an outside of the reactor body.

According to an embodiment, the conductive reactor body cover serves as the capacitively coupled electrode.

According to an embodiment, the conductive reactor body cover has a magnetic flux entrance opening.

According to an embodiment, the conductive reactor body cover has one or more electrical insulation regions for preventing generation of an eddy current.

According to an embodiment, the magnetic flux channel coupled plasma reactor includes an internal conductive cover installed in an inside of the reactor body.

According to an embodiment, the internal conductive cover has a magnetic flux entrance opening.

According to an embodiment, the internal conductive cover has one or more electrical insulation regions for preventing generation of an eddy current.

According to an embodiment, the reactor body is formed of a conductive body.

According to an embodiment, the reactor body includes a dielectric window disposed between the plasma discharge space and the magnetic flux entrance of the magnetic core.

According to an embodiment, the reactor body has one or more electrical insulation regions for preventing generation of an eddy current.

Another aspect according to the preferable embodiments of the present invention provides a magnetic flux channel coupled plasma reactor including: a hollow reactor body having a plasma discharge space coupled to magnetic flux channels; a magnetic flux channel coupled plasma source including magnetic cores having two or more magnetic flux entrances forming the magnetic channel and primary winding coils wound in the magnetic cores and generating magnetic flux channel coupled plasma in the plasma discharge space; an inductively coupled plasma source including inductive antenna coils mounted in the reactor body so as to form inductively coupled plasma in the plasma discharge space; and an AC switching power supply for supplying plasma generation power to the primary winding coils and the inductive antenna coils.

According to an embodiment, the reactor body is formed of a dielectric body.

According to an embodiment, the magnetic flux channel coupled plasma reactor includes a conductive reactor body cover surrounding an outside of the reactor body.

According to an embodiment, the conductive reactor body cover has a magnetic flux entrance opening.

According to an embodiment, the conductive reactor body cover has one or more electrical insulation regions for preventing generation of an eddy current.

Another aspect according to the preferable embodiments of the present invention provides a magnetic flux channel coupled plasma reactor including: a hollow reactor body having a plasma discharge space coupled to magnetic flux channels; a conductive reactor body cover surrounding an outside of the reactor body and having a magnetic flux entrance opening; a magnetic flux channel coupled plasma source including magnetic cores having two or more magnetic flux entrances forming the magnetic channel and primary winding coils wound in the magnetic cores and generating magnetic flux channel coupled plasma in the plasma discharge space; and an AC switching power supply for supplying plasma generation power to the primary winding coils and capacitively coupled electrodes.

According to an embodiment, the conductive reactor body cover has one or more electrical insulation regions for preventing generation of an eddy current.

Another aspect according to the preferable embodiments of the present invention provides a magnetic flux channel coupled plasma reactor including: a hollow reactor body having a plasma discharge space coupled to magnetic flux channels; an internal conductive cover installed in an inside of the reactor body and including a magnetic flux opening; a magnetic flux channel coupled plasma source having magnetic cores having two or more magnetic flux entrances forming the magnetic channel and primary winding coils wound in the magnetic cores and generating magnetic flux channel coupled plasma in the plasma discharge space; and an AC switching power supply for generating plasma generation power to the primary winding coils and capacitively coupled electrodes.

According to an embodiment, the internal conductive cover has one or more electrical insulation regions for preventing generation of an eddy current.

According to the present invention, the magnetic flux channel coupled plasma reactor forms multiple magnetic flux channels in the inside of the reactor body to generate magnetic flux channel coupled plasma, so that it has a high capability in control of plasma ion energy and a capability of processing of a large area to be easily extendible. Further, the magnetic flux channel coupled plasma reactor can generate hybrid plasma in which plasma coupled to multiple magnetic flux channels is combined with capacitively coupled plasma or inductively coupled plasma so as to achieve a wide operation region from a low-pressure region to a high-pressure region.

### BRIEF DESCRIPTION OF DRAWINGS

The above and other aspects, features and advantages of the present invention will be more apparent from the following detailed description taken in conjunction with the accompanying drawings, in which:

FIG. 1 is a block diagram illustrating a general construction of a magnetic flux channel coupled plasma reactor and a plasma processing system including the magnetic flux channel coupled plasma reactor according to the present invention;

FIG. 2 is a perspective vies illustrating a magnetic flux channel coupled plasma reactor according to an embodiment of the present invention;

FIG. 3 is a perspective view illustrating a horizontal cross-sectional structure of the magnetic flux channel coupled plasma reactor of FIG. 2;

FIG. 4 is an exploded perspective view illustrating the magnetic flux channel coupled plasma reactor of FIG. 2;

FIG. 5 is a horizontal cross-sectional view illustrating a magnetic flux channel coupled plasma reactor according to a modified embodiment;

FIG. 6 is a view illustrating a magnetic flux channel coupled plasma reactor including additional capacitively coupled electrodes according to the present invention;

FIG. 7 is a view illustrating an example of a disposition of capacitively coupled electrodes in an upper portion and a lower portion of a reactor body;

FIG. 8 is a view illustrating a magnetic flux channel coupled plasma reactor having a structure in which inductive antenna coils are installed in an outside of a reactor body;

FIG. 9 is a view illustrating an example of a magnetic flux channel coupled plasma reactor in which an internal conductive cover is installed in an inside of a reactor body; and

FIG. 10 is a view illustrating an example of a magnetic flux channel coupled plasma reactor in which dielectric windows are installed in a conductive reactor body.

### DESCRIPTION OF EMBODIMENTS

Hereinafter, an exemplary embodiment of the present invention will be described in detail with reference to the accompanying drawings for the full understanding of the present invention. The embodiment of the present invention will be modified into various forms and it shall not be construed that the scope of the present invention is limited to the embodiment to be described below. The embodiment of the present invention is provided to more fully explain the present invention to a skilled person in the art. Accordingly, a shape, or the like of an element in the drawing may be exaggerated for more accurate description. Like reference numerals indicate like elements throughout the specification and drawings. In the following description, detailed explanation of known related functions and constitutions may be omitted to avoid unnecessarily obscuring the subject manner of the present invention.

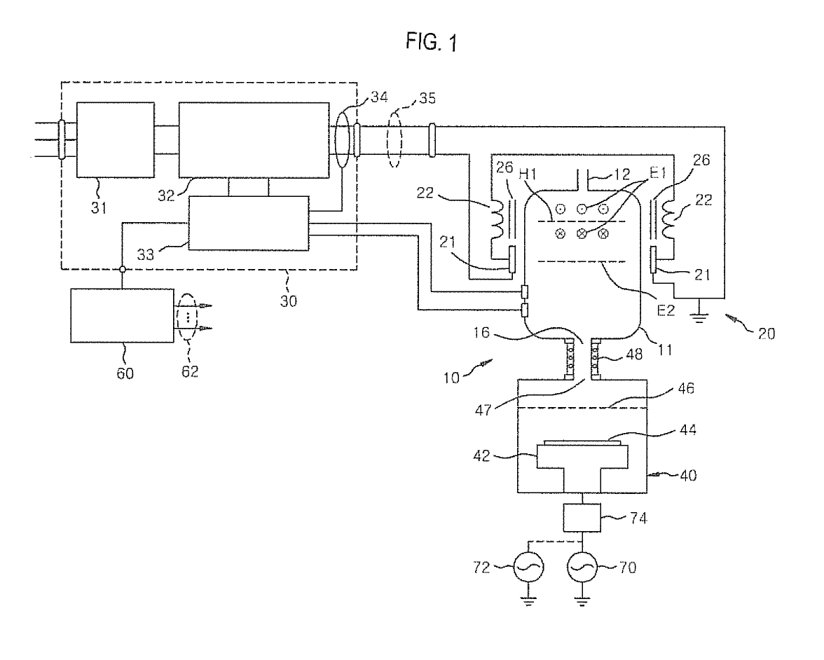

FIG. 1 is a block diagram illustrating a general construction of a magnetic flux channel coupled plasma reactor and a plasma processing system including the magnetic flux channel coupled plasma reactor of the present invention.

Referring to FIG. 1, a magnetic flux channel coupled plasma reactor 10 (hereinafter, simply referred to as “the plasma reactor”) of the preset invention is installed in an external side of a process chamber 40 and remotely supplies plasma to the process chamber 40. The plasma reactor 10 includes a hollow reactor body 11 having a magnetic flux channel coupled plasma discharge space and a magnetic flux channel coupled plasma source 20. The reactor body 11 includes a gas inlet 12 and a gas outlet 16. The gas outlet 16 is connected to a chamber gas inlet 47 of the process chamber 40 through an adapter 48. Plasma gas generated in the plasma reactor 10 is supplied to the process chamber 40 through an adapter 48.

The magnetic flux channel coupled plasma source 20 includes magnetic cores 26 having a magnetic flux entrance forming a magnetic flux channel and primary winding coils 22 wound in the magnetic cores 26. The reactor body 11 is positioned between two or more magnetic flux entrances of the magnetic cores 26, the detailed description of which will be described later. Accordingly, the reactor body 11 is coupled to the magnetic flux channels forming between the magnetic flux entrances, so that magnetic field H1 is formed in the plasma discharge space in an inside of the reactor body 11. Processing gas supplied to the inside of the reactor body 11 by an electric field E1 induced from the magnetic field H1 formed in the plasma discharge space in the inside of the reactor body 11 performs a magnetic flux channel coupled plasma discharge.

The plasma reactor 10 may further include capacitively coupled electrodes 21. The capacitively coupled electrodes 21 are installed in the reactor body 11 while the internal plasma discharge space of the reactor body 11 is interposed therebetween. Accordingly, a direct electric field E2 by the capacitively coupled electrode 21 is applied to the internal plasma discharge space of the reactor body 11, so that the processing gas supplied to the inside of the reactor body 11 performs a hybrid plasma discharge in which a magnetic flux channel coupled plasma discharge is combined with a capacitively coupled plasma discharge. The plasma reactor 10 of the present invention complexly generates magnetic flux channel coupled plasma and capacitively coupled plasma, so that it is possible to stably generate the plasma under a wide range of a pressure condition from a low pressure of 1 torr or lower to a high pressure of 10 torr or higher.

The process chamber 40 includes a substrate supporter 42 for supporting a substrate 44 to be processed in the inside thereof. The substrate supporter 42 is electrically connected to one or more bias power supplies 70 and 72 through an impedance matching device 74. The adapter 48 may include an insulation section for electrical insulation and a cooling channel for preventing overheating. The process chamber 40 includes a baffle 46 for distributing plasma gas between the substrate supporter 42 and the chamber gas inlet 47 in the inside thereof. The baffle 46 allows the plasma gas introduced through the chamber gas inlet 47 to be evenly distributed and diffused to the substrate 44 to be processed. For example, the substrate 44 to be processed is a silicon wafer substrate for manufacturing a semiconductor device or a glass substrate for manufacturing an LCD or a plasma display.

The magnetic flux channel coupled plasma source 20 is operated through receiving a wireless frequency from a power supply 30. The power supply 30 includes an AC switching power supply 32 including one or more switching semiconductor devices and generating a wireless frequency, a power control circuit 33, and a voltage supply 31. For example, the one or more switching semiconductor devices include one or more switching transistors. The voltage supply 31 converts an alternating voltage input from the outside to a constant voltage and supplies the converted voltage to the AC switching power supply 32. The AC switching power supply 32 is operated according to the control of the power control circuit 33 and generates the wireless frequency.

The power control circuit 33 controls an operation of the AC switching power supply 32 to control the voltage and the current of the wireless frequency. The control of the power control circuit 33 is performed based on an electrical or optical parameter value connected to at least one of the magnetic flux channel coupled plasma source 20 and the plasma generated in the inside of the reactor body 11. To this end, the power control circuit 33 includes a measurement circuit for measuring the electrical or optical parameter value. For example, the measurement circuit for measuring the electrical and optical parameter of the plasma includes a current probe and an optical detector. The measurement circuit for measuring the electrical parameter of the magnetic flux channel coupled plasma source 20 measures a driving current, a driving voltage, an average power, and a maximum power of the magnetic flux channel coupled plasma source 20 and a voltage generated in the voltage supply 31.

The power control circuit 33 controls the voltage and the current of the wireless frequency through controlling the AC switching power supply 32 while continuously monitoring the related electrical or optical parameter value through the measurement circuit and comparing the measured value and a reference value based on a normal operation. Although it is not specifically illustrated, the power supply 30 includes a protection circuit for preventing an electrical damage which may be generated due to an abnormal operation environment. The power supply 30 is connected to a system controller 60 for generally controlling the plasma processing system. The power supply 30 provides the system controller 60 with operation state information on the plasma reactor 10. The system controller 60 generates a control signal for generally controlling the general operation of the plasma processing system and controls the operation of the plasma reactor 10 and the process chamber 40.

The plasma reactor 10 and the power supply 30 have a physically separated structure. That is, the plasma reactor 10 is electrically connected to the power supply 30 by a wireless frequency supply cable 35. The separation structure of the plasma reactor 10 and the power supply 30 secures easy repair and maintenance and easy installation. However, the plasma reactor 10 may be integrally formed with the power supply 30.

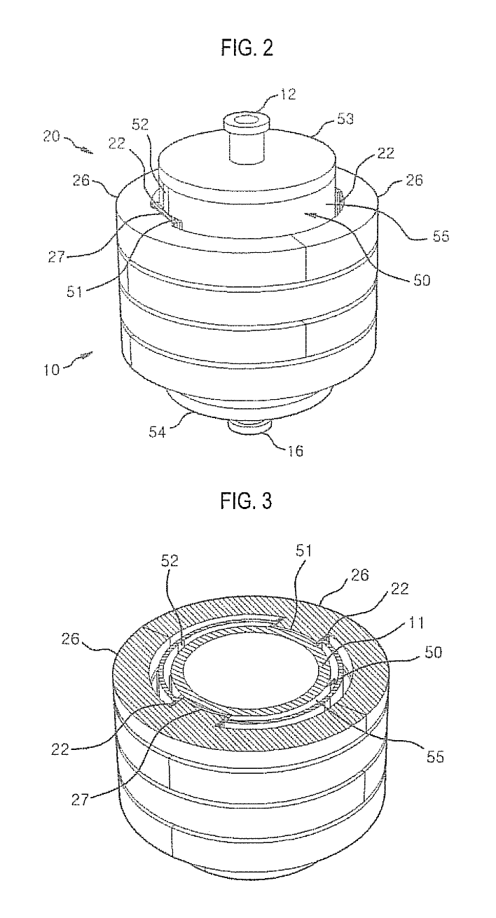

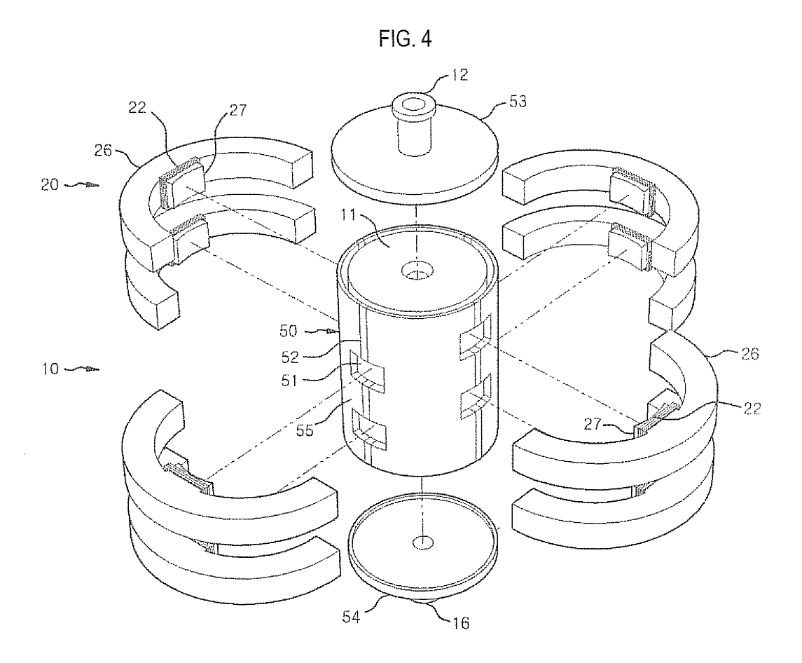

FIG. 2 is a perspective vies illustrating a magnetic flux channel coupled plasma reactor according to an embodiment of the present invention, FIG. 3 is a perspective view illustrating a horizontal cross-sectional structure of the magnetic flux channel coupled plasma reactor of FIG. 2, and FIG. 4 is an exploded perspective view illustrating the magnetic flux channel coupled plasma reactor of FIG. 2.

Referring to FIGS. 2 to 4, the plasma reactor 10 according to the embodiment of the present invention includes the hollow reactor body 11 having a magnetic flux channel coupled plasma discharge space. The reactor body 11 includes a cylindrical structure and is surrounded by a reactor body cover 50. The gas inlet is connected to an upper portion of the reactor body and the gas outlet 16 is connected to a lower portion of the reactor body 11. The reactor body cover 50 includes an upper cover 53, a lower cover 54, and a body 55. The reactor body cover 50 has a plurality of magnetic flux entrance through-openings 51. If the reactor body cover 50 is made of a conductive metal, it is preferable to include the insulation section 52 for preventing generation of an eddy current in the reactor body cover 50 by the magnetic flux channel.

The pair of magnetic flux entrance through-openings 51 are formed in the reactor body 50 such that they face each other while the reactor body 11 is interposed between the pair of magnetic flux entrance through-openings 51. The pair of magnetic flux entrances 27 of the magnetic cores 26 are inserted in the facing magnetic flux entrance through-openings 51. The plurality of magnetic cores 26 including the pair of facing magnetic flux entrances 27 are installed in several regions of the reactor body 11. The primary winding coil 22 of the magnetic core 26 is wound around the magnetic flux entrance 27. The plurality of primary winding coils 22 wound in the plurality of magnetic cores 26 may be connected to the power supply 30 in series, in parallel, or in a serial-parallel combination scheme.

When a power is applied to the primary winding coil 22, the magnetic flux channel coupled to the reactor body 11 is formed. Gas introduced to the inside of the reactor body 11 through the gas inlet 12 is accelerated by an electric field formed by the magnetic flux channel, so that the magnetic flux channel coupled plasma discharge is created. The plasma gas formed in the internal plasma discharge space of the reactor body 11 is supplied to the process chamber 40 through the gas outlet 16.

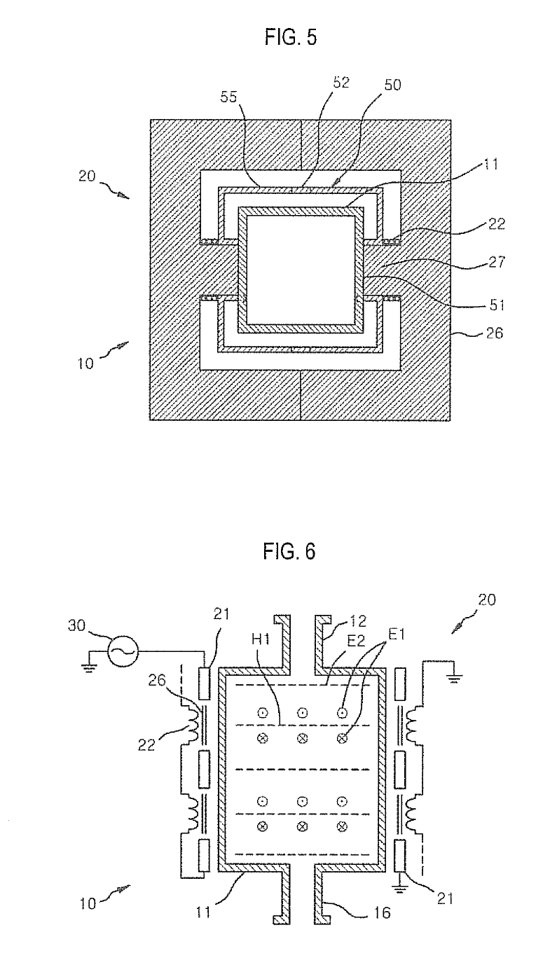

According to an modified embodiment illustrated in FIG. 5, the plasma reactor 10 may include the reactor body 11 and the magnetic cores 26 having a quadrangle plane section structure. As such, the shape of the reactor body 11 and the magnetic core may be variously changed.

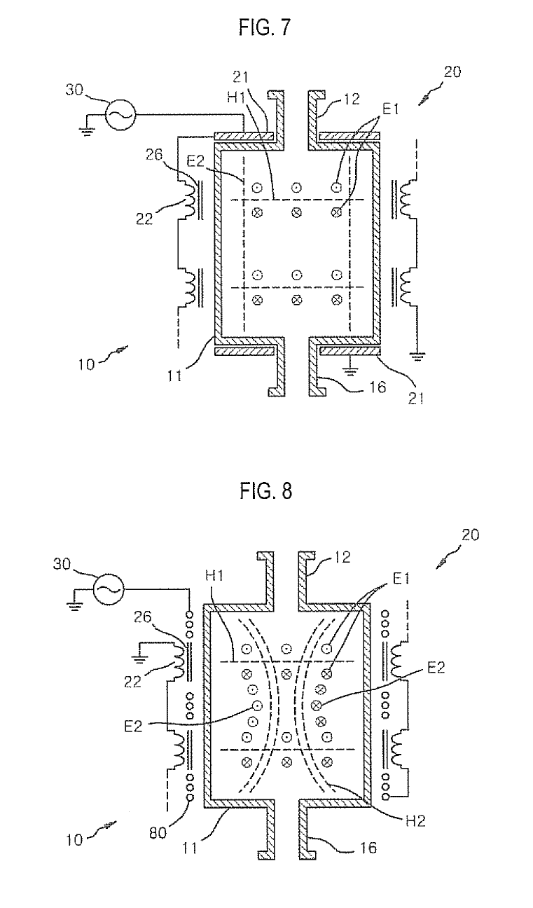

FIG. 6 is a view illustrating the magnetic flux channel coupled plasma reactor including additional capacitively coupled electrodes according to the present invention and FIG. 7 is a view illustrating an example of a disposition of capacitively coupled electrodes in the upper portion and the lower portion of the reactor body.

Referring to FIG. 6, the magnetic flux channel coupled plasma reactor 10 according to another embodiment of the present invention may include the capacitively coupled electrodes 21 installed around an outside of the reactor body 11. The plurality of primary winding coils 22 and the capacitively coupled electrodes 21 may have an electrically connected structure, such as a serial connection, a parallel connection, a serial-parallel combined connection. The electric field E1 induced by the magnetic field H1 formed between the magnetic flux entrances of the magnetic cores 26 and the electric field E2 directly formed between the capacitively coupled electrodes 21 exist together in the inside of the reactor body 11. Accordingly, there occurs the hybrid plasma discharge in which a magnetic flux channel coupled plasma discharge is combined with a capacitively coupled plasma discharge. The hybrid plasma discharge structure can stably generate the plasma under a wide range of a pressure condition from a low pressure of 1 torr or lower to a high pressure of 10 torr or higher.

When the reactor body cover 50 is made of a conductive metal, the reactor body cover 50 may serve as the capacitively coupled electrode. For example, as illustrated in FIG. 6, the reactor body cover 50 may serve as the capacitively coupled electrode such that the electric field E2 is horizontally formed in the inside of the reactor body 11, or as illustrated in FIG. 7, the upper cover 53 and the lower cover 54 may serve as the capacitively coupled electrode such that the electric field E2 is vertically formed in the inside of the reactor body 11.

FIG. 8 is a view illustrating the magnetic flux channel coupled plasma reactor having a structure in which inductive antenna coils are installed in the outside of the reactor body.

Referring to FIG. 8, the magnetic flux channel coupled plasma reactor 10 according to another embodiment of the present invention includes the inductive antenna coils 80 to generate hybrid plasma in which magnetic flux coupled plasma and inductively coupled plasma are combined. The reactor body 11 is formed of a dielectric material and the inductive antenna coil 80 is wound around the external side thereof. The inductive antenna coils 80 are connected to the power supply 30 through serial, parallel, or serial-parallel combined connection with the primary winding coils 22 wound in the plurality of magnetic cores 26. The electric field E1 induced from the magnetic field H1 by the magnetic cores 26 and the electric field E2 induced from the magnetic field H2 by the inductive antenna coils 80 exist together in the inside of the reactor body 11. Accordingly, there occurs the hybrid plasma discharge in which a magnetic flux channel coupled plasma discharge is combined with an inductively coupled plasma discharge in the inside of the reactor body 11. The aforementioned hybrid plasma discharge structure can stably generate the plasma under a wide range of a pressure condition from a low pressure of 1 torr or lower to a high pressure of 10 torr or higher.

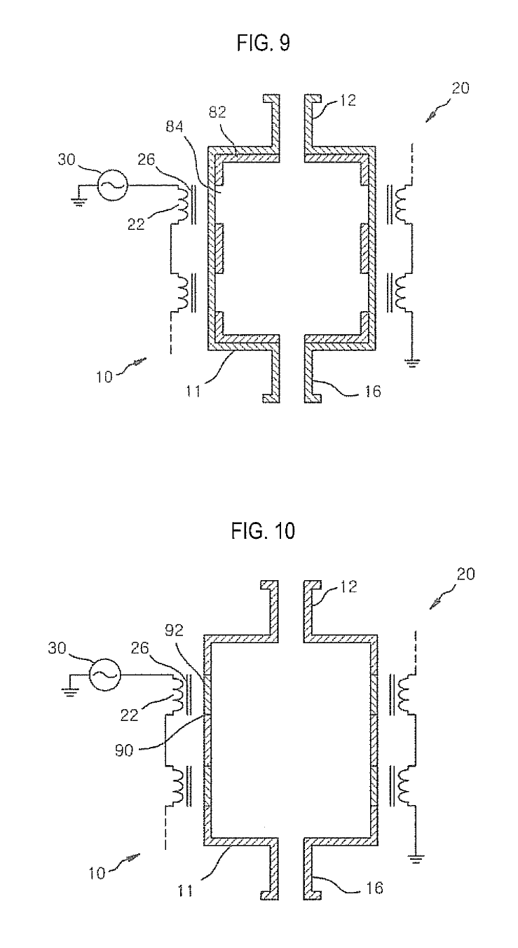

FIG. 9 is a view illustrating an example of the magnetic flux channel coupled plasma reactor in which an internal conductive cover is installed in an inside of the reactor body.

Referring to FIG. 9, the magnetic flux channel coupled plasma reactor 10 according to another embodiment of the present invention includes an internal conductive cover 82 made of a metal material in the inside of the reactor body 11 formed of the dielectric material. The internal conductive cover 82 includes magnetic entrance openings 84 corresponding to the magnetic entrances of the magnetic cores 26. Since the internal conductive cover 82 is made of a metal material, it is preferable to include one or more electrical insulation regions (not shown) for preventing an eddy current which may be generated around the magnetic flux channel.

FIG. 10 is a view illustrating an example of the magnetic flux channel coupled plasma reactor in which dielectric windows are installed in the conductive reactor body.

Referring to FIG. 10, the magnetic flux channel coupled plasma reactor 10 according to another embodiment of the present invention includes the reactor body 11 made of a metal material. The reactor body 11 includes a plurality of magnetic flux entrance openings 90 at parts coupled to the magnetic flux channels. Dielectric windows 92 are installed in the magnetic flux entrance openings 90. The dielectric window 92 and the reactor body 11 are vacuum sealed by a vacuum sealing member (not shown). Since the reactor body 11 is made of a metal material, it is preferable to include one or more electrical insulation regions (not shown) for preventing an eddy current which may be generated around the magnetic flux channel.

It is easy to manufacture the aforementioned magnetic flux channel coupled plasma reactor 10 through appropriately adjusting a volume of the reactor body 11 and the number of magnetic cores 26 and primary winding coils 22 for forming the magnetic flux channel depending on a capacity of plasma required in the process chamber. The single reactor body 11 is coupled to multiple magnetic flux channels, and in this case, it is possible to variably control a capacity and a density of total plasma generated in the inside of the reactor body 11 through appropriately adjusting the number of coupled magnetic flux channels. In this case, a control circuit, such as a switching circuit, for partially and selectively driving the plurality of primary winding coils 22 may be added for the adjustment of the number of generated magnetic flux channels. The magnetic flux channel coupled plasma reactor 10 forms the multiple magnetic flux channels in the inside of the reactor body 11, so that it is possible to easily ignite plasma and maintain the ignited plasma in a low pressure region and generate a large volume of plasma without internal damage of the reactor in a high pressure region.

As can be seen through the several embodiments, the magnetic flux channel coupled plasma reactor 10 can independently generate the magnetic flux channel coupled plasma or generate the hybrid plasma through the capacitively coupled electrodes 21 or the inductive antenna coils 80 in the inside of the reactor body. The reactor body 11 may be made of a conductive metal material or a non-conductive dielectric material. When the reactor body 11 is made of the conductive material, it is preferable to include an electrical insulation region for preventing the generation of an eddy current. Although it is not specifically described, the magnetic flux channel coupled plasma reactor 10 includes a cooling channel for controlling a temperature.

The cooling channel is installed at an appropriate part of the plasma reactor 10. For example, the cooling channel may be installed in the reactor body 11 or the reactor body cover 50. Otherwise, a component for installing a separate cooling channel may be additionally installed.

The foregoing is merely an exemplary embodiment of the magnetic flux channel coupled plasma reactor according to the present invention, and it will be readily understood by those skilled in the art that various modifications and changes can be made thereto within the technical spirit and scope of the present invention, and the scope of the present invention shall not be limited to the described embodiment. Accordingly, the technical protective scope of the present invention shall be defined by the technical spirits of the accompanied claims. Further, those skilled in the art will appreciate that the present invention includes all modifications, equivalents, and substitutes within the scope of the spirit of the present invention defined by the accompanied claims.

What is claimed is:

1. A magnetic flux channel coupled plasma reactor comprising:
a hollow reactor body having a plasma discharge space coupled to magnetic flux channels;
a magnetic flux channel coupled plasma source including magnetic cores having two or more magnetic flux entrances forming the magnetic channel and primary winding coils wound in the magnetic cores and generating magnetic flux channel coupled plasma in the plasma discharge space;
capacitively coupled electrodes capacitively coupled while the plasma discharge space is interposed therebetween to generate capacitively coupled plasma in the plasma discharge space; and
an AC switching power supply for supplying plasma generation power to the primary winding coils and the capacitively coupled electrodes.

2. The magnetic flux channel coupled plasma reactor as claimed in claim 1, wherein the reactor body is formed of a dielectric body.

3. The magnetic flux channel coupled plasma reactor as claimed in claim 2, comprising a conductive reactor body cover surrounding an outside of the reactor body.

4. The magnetic flux channel coupled plasma reactor as claimed in claim 3, wherein the conductive reactor body cover serves as the capacitively coupled electrode.

5. The magnetic flux channel coupled plasma reactor as claimed in claim 3, wherein the conductive reactor body cover has a magnetic flux entrance opening.

6. The magnetic flux channel coupled plasma reactor as claimed in claim 3, wherein the conductive reactor body cover has one or more electrical insulation regions for preventing generation of an eddy current.

7. The magnetic flux channel coupled plasma reactor as claimed in claim 2, comprising an internal conductive cover installed in an inside of the reactor body.

8. The magnetic flux channel coupled plasma reactor as claimed in claim 7, wherein the internal conductive cover has a magnetic flux entrance opening.

9. The magnetic flux channel coupled plasma reactor as claimed in claim 7, wherein the internal conductive cover has one or more electrical insulation regions for preventing generation of an eddy current.

10. The magnetic flux channel coupled plasma reactor as claimed in claim 1, wherein the reactor body is formed of a conductive body.

11. The magnetic flux channel coupled plasma reactor as claimed in claim 10, wherein the reactor body comprises a dielectric window disposed between the plasma discharge space and the magnetic flux entrance of the magnetic core.

12. The magnetic flux channel coupled plasma reactor as claimed in claim 10, wherein the reactor body has one or more electrical insulation regions for preventing generation of an eddy current.

13. A magnetic flux channel coupled plasma reactor comprising:
a hollow reactor body having a plasma discharge space coupled to magnetic flux channels;
a magnetic flux channel coupled plasma source including magnetic cores having two or more magnetic flux entrances forming the magnetic channel and primary winding coils wound in the magnetic cores and generating magnetic flux channel coupled plasma in the plasma discharge space;
an inductively coupled plasma source including inductive antenna coils mounted in the reactor body so as to form inductively coupled plasma in the plasma discharge space; and
an AC switching power supply for supplying plasma generation power to the primary winding coils and the inductive antenna coils.

14. The magnetic flux channel coupled plasma reactor as claimed in claim 13, wherein the reactor body is formed of a dielectric body.

15. The magnetic flux channel coupled plasma reactor as claimed in claim 14, comprising a conductive reactor body cover surrounding an outside of the reactor body.

16. The magnetic flux channel coupled plasma reactor as claimed in claim 15, wherein the conductive reactor body cover has a magnetic flux entrance opening.

17. The magnetic flux channel coupled plasma reactor as claimed in claim 15, wherein the conductive reactor body cover has one or more electrical insulation regions for preventing generation of an eddy current.

18. A magnetic flux channel coupled plasma reactor comprising:
a hollow reactor body having a plasma discharge space coupled to magnetic flux channels;
a conductive reactor body cover surrounding an outside of the reactor body and having a magnetic flux entrance opening;
a magnetic flux channel coupled plasma source including magnetic cores having two or more magnetic flux entrances forming the magnetic channel and primary winding coils wound in the magnetic cores and generating magnetic flux channel coupled plasma in the plasma discharge space; and
an AC switching power supply for supplying plasma generation power to the primary winding coils and capacitively coupled electrodes.

19. The magnetic flux channel coupled plasma reactor as claimed in claim 18, wherein the conductive reactor body cover has one or more electrical insulation regions for preventing generation of an eddy current.

20. A magnetic flux channel coupled plasma reactor comprising:
a hollow reactor body having a plasma discharge space coupled to magnetic flux channels;
an internal conductive cover installed in an inside of the reactor body and including a magnetic flux opening;
a magnetic flux channel coupled plasma source having magnetic cores having two or more magnetic flux entrances forming the magnetic channel and primary winding coils wound in the magnetic cores and generating magnetic flux channel coupled plasma in the plasma discharge space; and
an AC switching power supply for generating plasma generation power to the primary winding coils and capacitively coupled electrodes.

21. The magnetic flux channel coupled plasma reactor as claimed in claim 20, wherein the internal conductive cover has one or more electrical insulation regions for preventing generation of an eddy current.
